(19) United States
(12) Patent Application Publication
(10) Pub. No.: US 2009/0132574 A1
(43) Pub. Date: May 21, 2009

(54) DYNAMIC BEST PRACTICES INTEGRATION

(75) Inventors: Adrian Dumitrascu, Redmond, WA (US); Matthew E. Carroll, Seattle, WA (US); Robert B. Zare, Issaquah, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/941,989

(22) Filed: Nov. 19, 2007

(51) Int. Cl. G06F 17/00

(52) U.S. Cl. 707/102; 707/E17.005

(57) ABSTRACT

Various technologies and techniques are disclosed for integrating best design practices with a database. Rules for best design practices are integrated into an object model of a database. As the database design changes, violations to the rules are detected. Notifications are output for the violations of the rules. The system detects when a change to the database design that is made in a development environment causes a violation to a best design practice. The violation to the best design practice is indicated to the user. A database can be validated upon request to detect any violations of best design practices. A request is received to validate a selected database for best design practices. A best design practices check is performed against the selected database to identify if any violations are present. Any violations are output that were identified while performing the best design practices check.

### BACKGROUND

Databases can be very complex in nature. Take online analytical processing (OLAP) databases as an example. OLAP databases have a multidimensional data model, which is designed to allow complex analytical and ad-hoc queries to be executed. In order to generate a multidimensional data model, OLAP databases have various attributes and relationships that have numerous interdependencies between them. In order to design an OLAP database optimally, an extensive amount of knowledge is required. Unfortunately, since OLAP databases are so complicated to design, most database designers do not have an extensive amount of knowledge in how to create such designs using good design practices. What usually happens it that database designers build less than optimal designs, which can lead to unexpected results, poor performance, or a confusing end user model.

### SUMMARY

Various technologies and techniques are disclosed for integrating best design practices with a database. Rules for best design practices are integrated into an object model of a database. As the database design changes, violations to the rules are detected. Notifications are output for the violations of the rules, such as for display to a user.

In one implementation, violations to best design practices are indicated in real time. The system detects when a change to the database design that is made in a development environment causes a violation to at least one best design practice. The violation to the best design practice is then indicated in real time to the user, such as visibly or audibly.

In one implementation, a database can be validated upon request to detect any violations of best design practices. A request is received to validate a selected database for best design practices. A best design practices check is performed against the selected database to identify if any violations are present. Any violations are output that were identified while performing the best design practices check.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a best design practice integration system of one implementation.

FIG. 2 is a process flow diagram for one implementation illustrating the stages involved in including best design practices into a database object model.

FIG. 3 is a process flow diagram for one implementation illustrating the stages involved in identifying a best design practice violation.

FIG. 4 is a simulated screen of one implementation illustrating the display of a best design practice violation using a tooltip in a development environment.

FIG. 5 is a simulated screen of one implementation illustrating a visual indication of best design practice violations on dimensions within an OLAP model.

FIG. 6 is a process flow diagram for one implementation illustrating the stages involved in validating a database against best design practices upon build of associated project in a software development application.

FIG. 7 is a simulated screen for one implementation illustrating best design practice violations being included in a warning list after a build process.

FIG. 8 is a process flow diagram for one implementation that illustrates the stages involved in validating a database against best design practices upon request.

FIG. 9 is a simulated screen for one implementation illustrating the dismissal of a best design practice violation warning.

FIG. 10 is a simulated screen for one implementation illustrating more details about a selected best design practices violation that was presented as a warning.

FIG. 11 is a process flow diagram for one implementation that illustrates the stages involved in viewing best design practice warning rules applicable to a database and/or those warnings that have been dismissed.

FIG. 12 is a simulated screen for one implementation illustrating the best design practice rules being applied and any warnings of best design practice violations that have been dismissed.

FIG. 13 is a diagrammatic view of a computer system of one implementation.

### DETAILED DESCRIPTION

The technologies and techniques herein may be described in the general context as database technologies for integrating best design practices, but the technologies and techniques also serve other purposes in addition to these. In one implementation, one or more of the techniques described herein can be implemented as features within a database program such as MICROSOFT® SQL Server™, from within a software development program such as MICROSOFT® VISUAL STUDIO®, or from any other type of program or service that creates and/or manages databases.

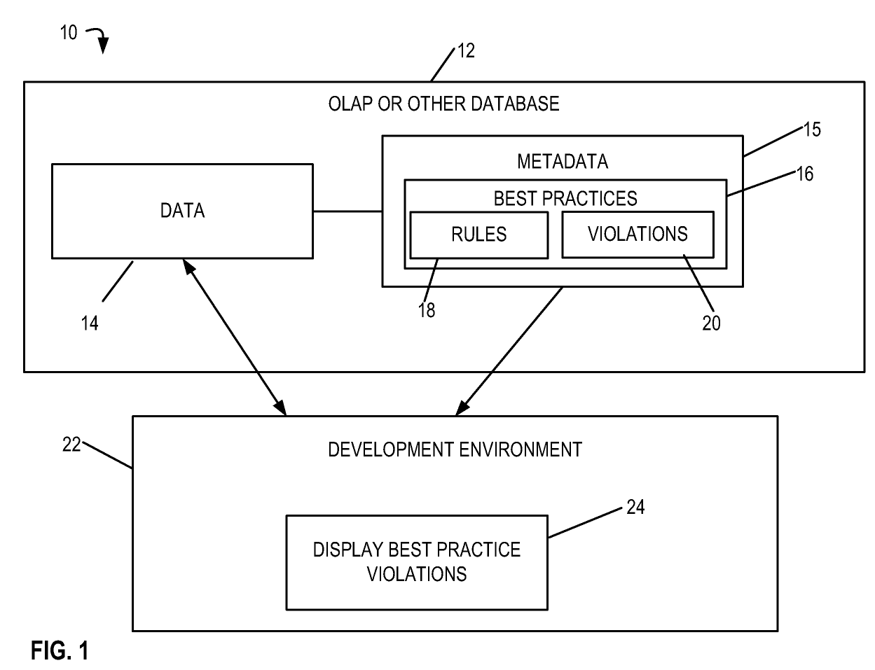

FIG. 1 is a diagrammatic view of a best design practice integration system 10 of one implementation. Best design practice integration system 10 contains a database 12 such as an OLAP database or another type of database. A few non-limiting examples of other types of databases include a relational database and a data mining database. Database 12 contains underlying data 14, and also contains metadata 15 for providing additional details about the database 12, such as database definitions. In one implementation, metadata 15 includes rules 18 for best design practices 16, and violations 20 of those rules 18. In one implementation, the best design practices 16 are integrated into an object model of the database. The term “object model” as used herein is meant to include an application programming interface that allows a database to be accessed and/or manipulated.

A non-limiting example will be described to further illustrate the concept of how best practices could be integrated into an object model of a database. This example will discuss an OLAP database. Suppose an OLAP server takes a definition of an OLAP database and uses it to build the actual OLAP database containing data (which is read from other sources). This definition of the OLAP database tells the server what cubes to create, what measures and dimensions they will contain, what each attribute in each dimension looks like, etc. Based on the definition, the server knows both the structure to create and where to fetch the data from that will populate the structure. This definition of the database can be in an XML file (or set of files), in a data store, or other locations, depending on the OLAP database implementation. Suppose the database has an object model (API) that reflects the structure of this database definition and makes it much easier to work with.

In this hypothetical example, the OLAP database is located on one or more servers, and contains data and can be queried from the database definition which is manipulated by the object model. In this hypothetical example, the object model is also where the best practice rules are implemented as well as the list of violations to be ignored. Because the object model is publicly accessible, users can write their own applications or scripts that use the object model to create or maintain OLAP databases and these applications or scripts can use some or all of the best practices validation techniques described herein.

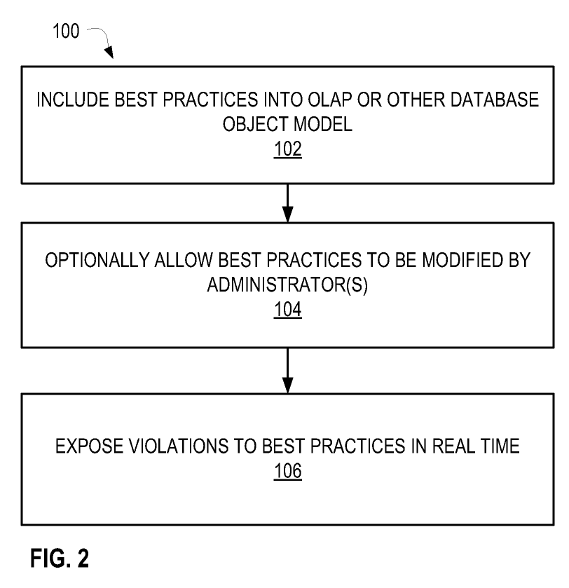

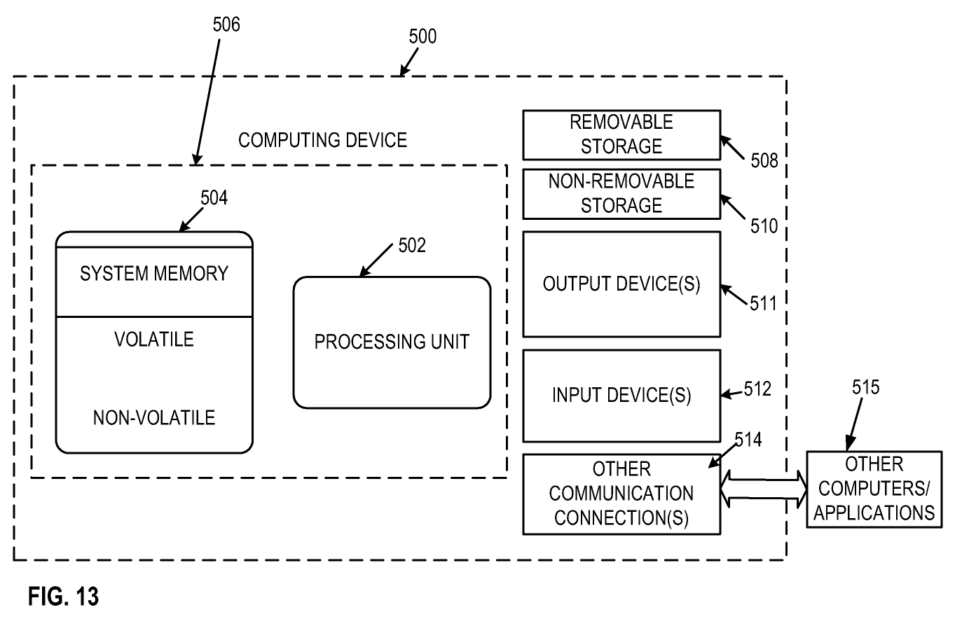

Turning now to FIGS. 2-12, the stages for implementing one or more implementations of a best design practice integration system 10 are discussed. In some implementations, the processes of FIG. 2-12 are at least partially implemented in the operating logic of computing device 500 (of FIG. 13).

FIG. 2 is a process flow diagram 100 for one implementation illustrating the stages involved in including best design practices into a database object model. Best design practices are included in an OLAP or other database object model (stage 102). Best design practices can optionally be modified by administrator(s) (stage 104). In some implementations, an option to modify best design practices is supported in the database, such as to allow for additional best practices to be added to the rules, or to allow logic for existing rules to be modified. In another implementation, modifications are not allowed to the rules themselves in order to preserve the integrity of the rules. Violations to best design practices are exposed in real time as users interact with the database, and/or upon request, such as when a request to validate a database design is received (stage 106).

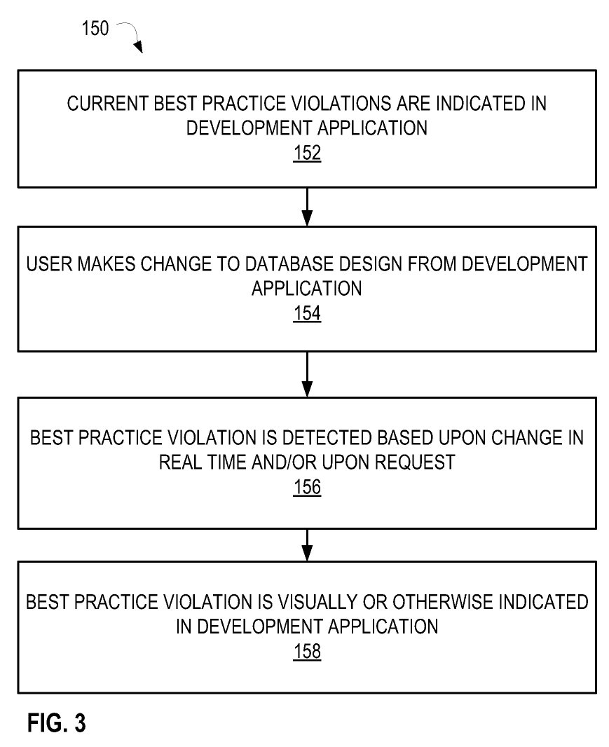

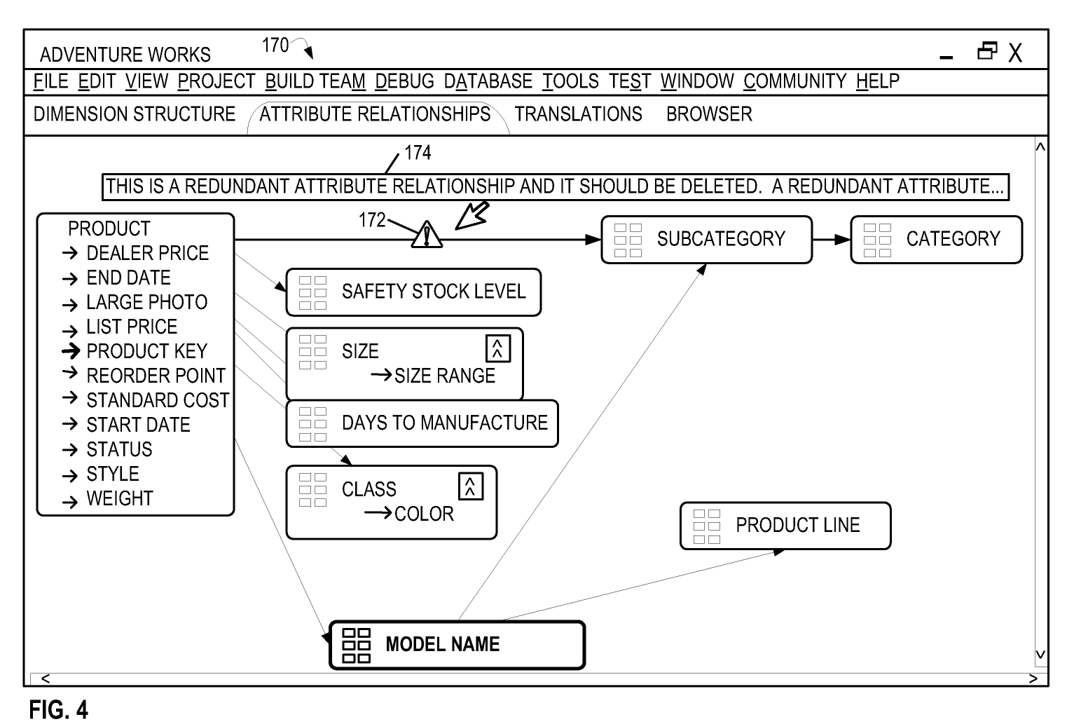

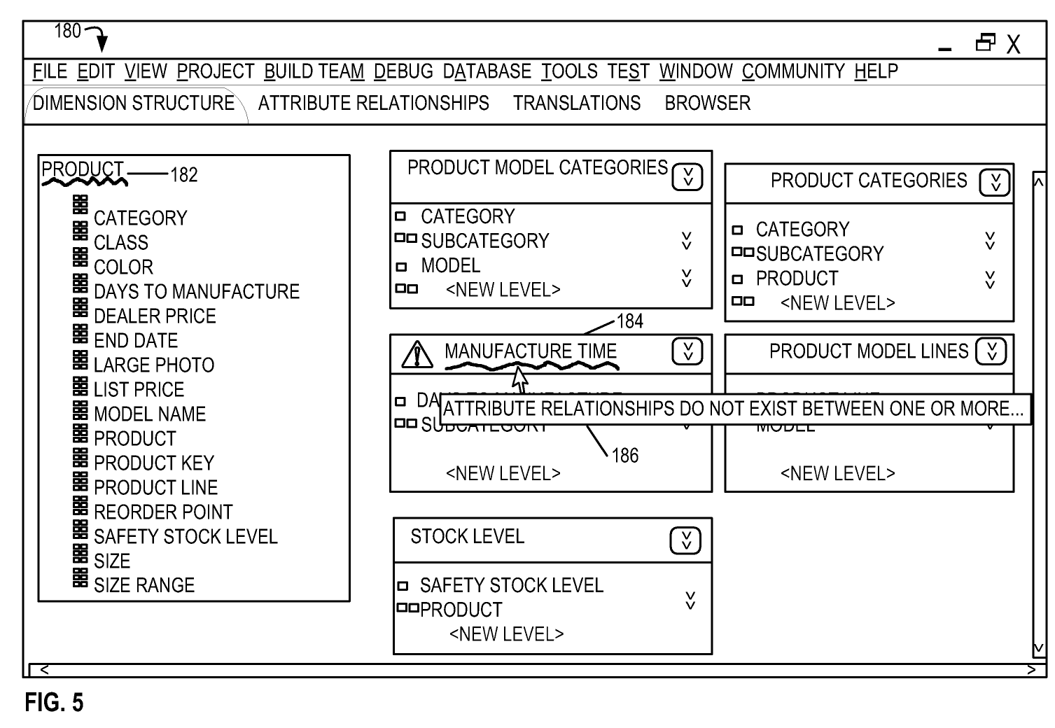

FIG. 3 is a process flow diagram 150 for one implementation illustrating the stages involved in identifying a best design practice violation. The current best design practice violations are indicated in development application (stage 152), such as when the development application loads a given project. The term “development application” as used herein is meant to include any type of application or script which interacts with the design of a database or databases which are based on a system which contains best design practices. A user makes a change to the database design from the development application (stage 154). When the change is made, any best design practice violations that were caused by the change are detected in real time and/or upon request (stage 156). The best design practice violation(s) is/are then visually displayed or otherwise indicated in the development application (stage 158), such as with a sound. FIGS. 4 and 5 provide some examples of how best design practice violations can be visually indicated in a development application.

FIG. 4 is a simulated screen 170 of one implementation illustrating the display of a best design practice violation using a tooltip 174 in a development environment. The best design practice violation is visually indicated with a graphic icon 172, and when the user hovers the input device pointer over the region where the graphic icon 172 is located, the tooltip 174 appears to give more details about the best design practice violation. In the OLAP database example shown, the violation indicates that the particular relationship is a redundant attribute relationship that should be deleted.

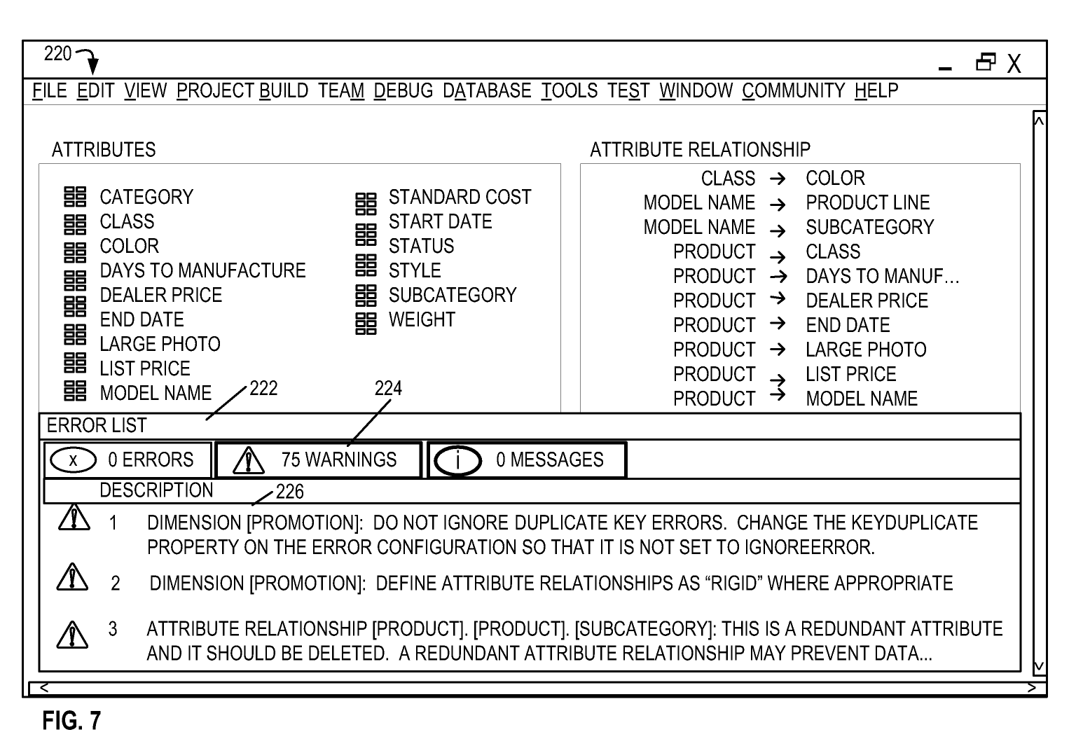

FIG. 5 is a simulated screen 180 of one implementation illustrating a visual indication of best design practice violations on dimensions (182 and 184) within an OLAP model. In this example, jagged lines are used to visually indicate that the dimensions (182 and 184) have a best design practice violation. Similarly to FIG. 4, when the user hovers the input device pointer over the region where a jagged line with a best design practice violation appears, a tooltip 186 is displayed. In this example, the manufacture time dimension 184 has a violation, and the tooltip 186 indicates a problem about attribute relationships not existing as expected. Although the simulated screens in FIGS. 4 and 5 use graphical icons, jagged lines, and tooltips to visually indicate best practice violations, it will be appreciated that any way of visually indicating that a violation has occurred could also be used. Some additional examples of visual indicators will be shown in later figures, such as FIGS. 7, 10, and 12.

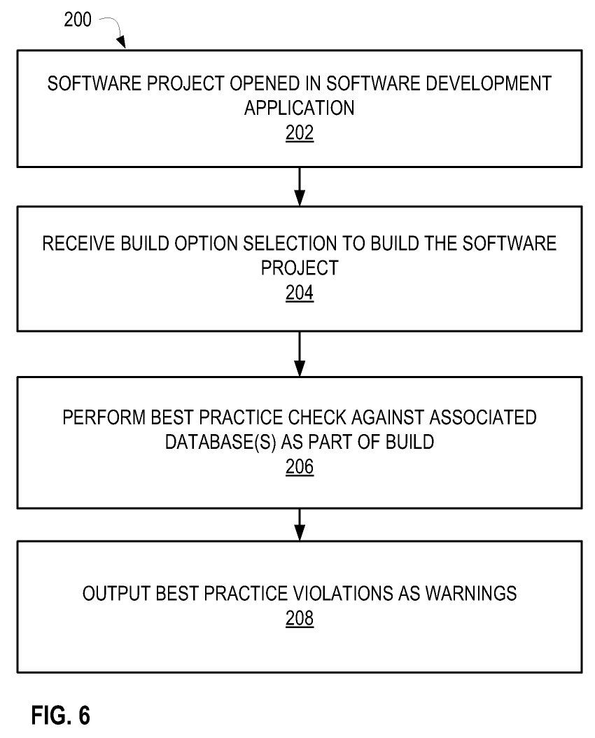

Turning now to FIG. 6, a process flow diagram 200 is shown for one implementation that illustrates the stages involved in validating a database against best design practices upon build of an associated project in a software development application. A software project is opened in a software development application (stage 202). A build option selection is received from the user (or programmatically) to build the software project (stage 204). The system performs a best design practice check against associated database(s) as part of the build process (stage 206). Any best design practice violations are indicated as warnings to the build (stage 208). In one implementation, best design practice violations are intermixed in a list with other warnings to the software build. In another implementation, best design practice violations are listed in their own separate group of warnings. FIG. 7 is a simulated screen 220 that illustrates how best design practice violations 226 can be intermixed with other warnings in a warning section 224 of an error list 222 that was generated during a build process.

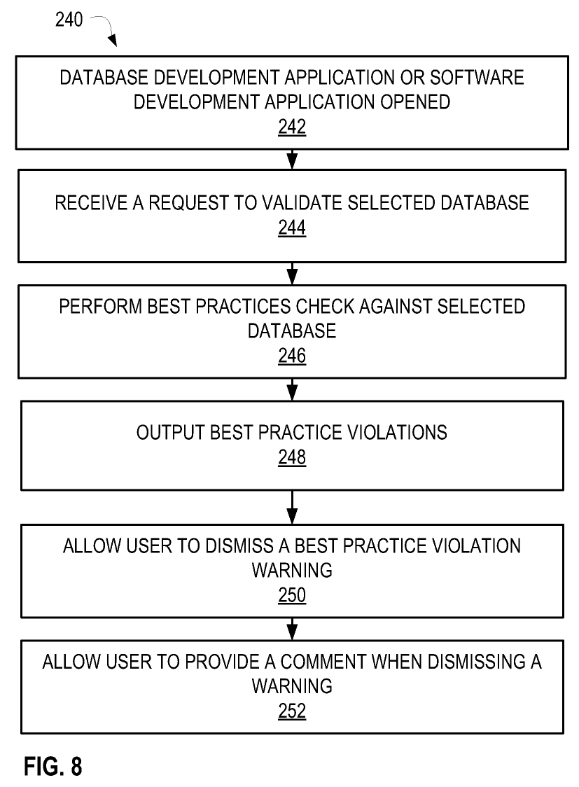

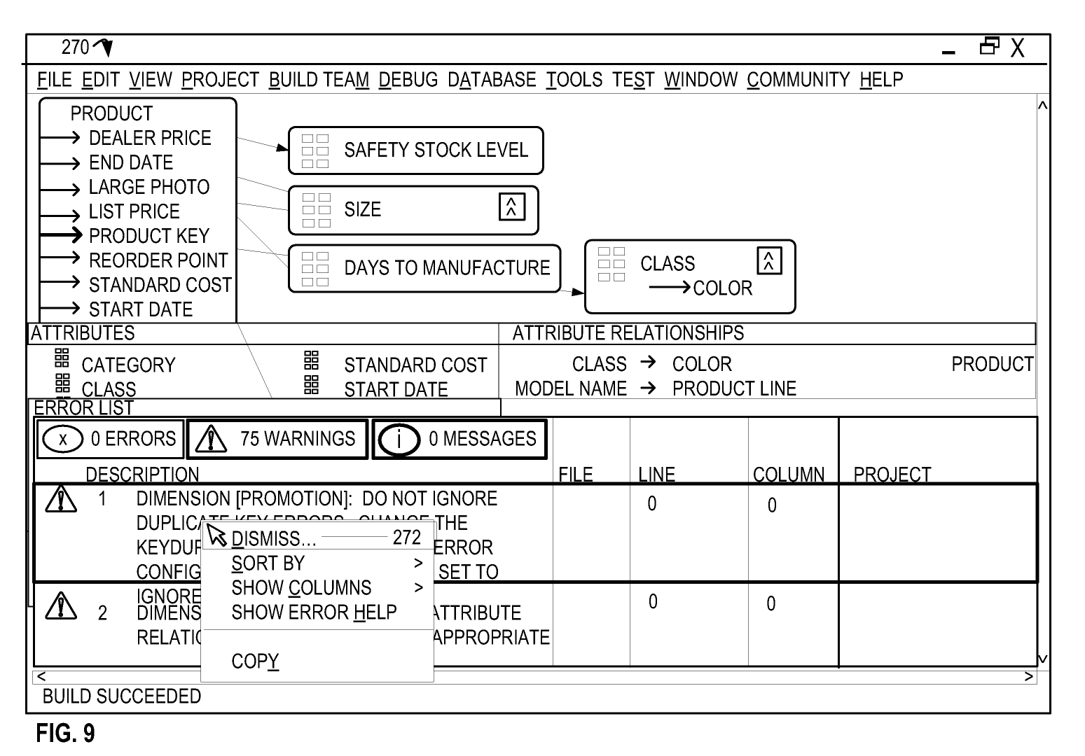

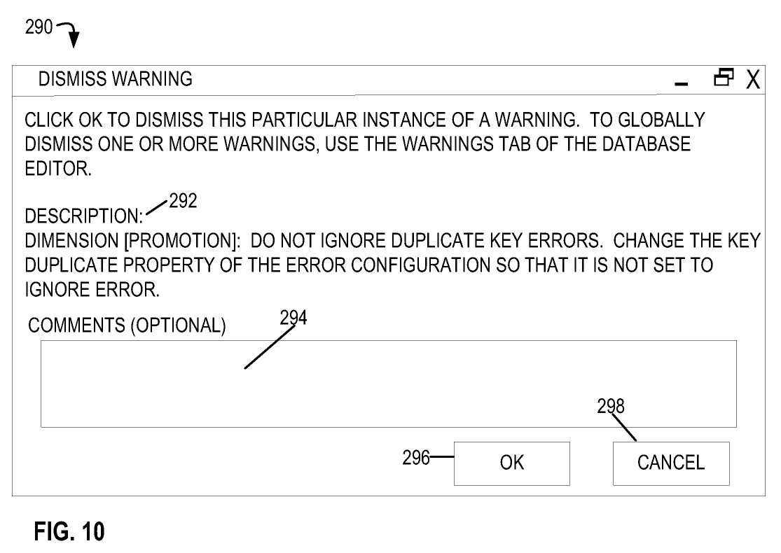

Turning now to FIG. 8, a process flow diagram 240 for one implementation is shown that illustrates the stages involved in validating a database against best design practices upon request, such as upon user request, or programmatically from a software process. The database development application or software development application is optionally opened (stage 242), such as when the user will be making the validation request. A request to validate a selected database is received (stage 244), and a best design practice check is then performed against the selected database (stage 246). The system outputs any best design practice violations that were identified during the best design practice check (stage 248). The user is provided with a mechanism to dismiss best design practice violation warnings (stage 250), and to optionally provide a comment when dismissing a respective warning (stage 252), as illustrated further in FIGS. 9 and 10.

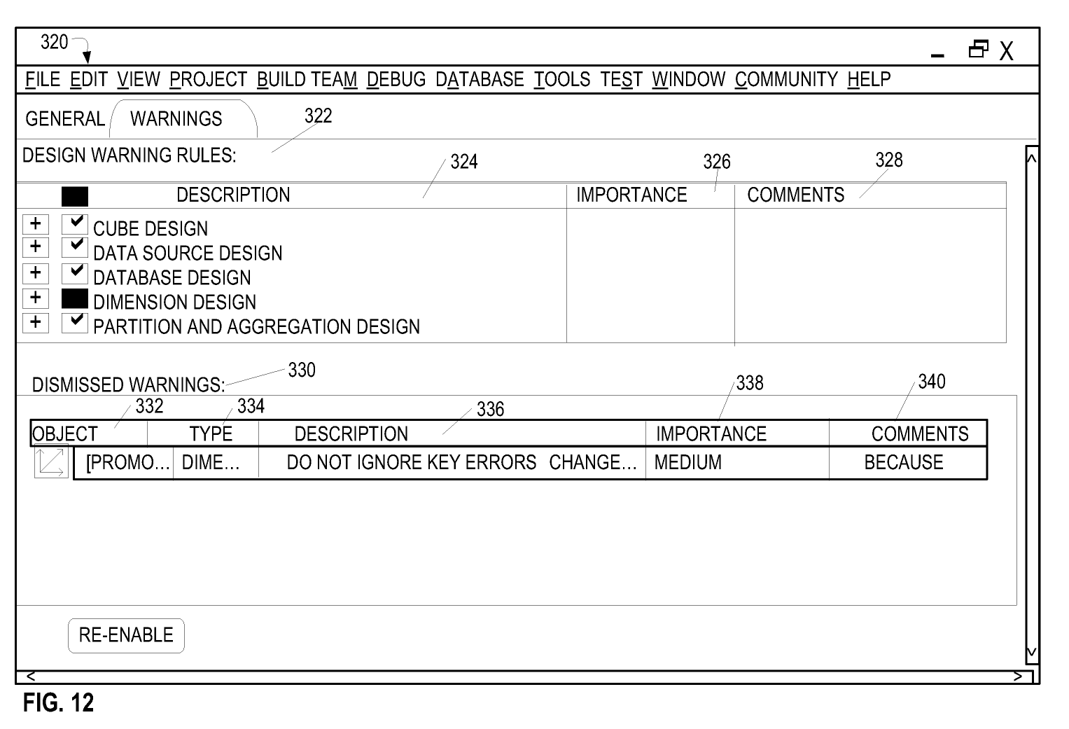

FIG. 9 is a simulated screen 270 for one implementation that illustrates the user selecting a dismissal option 272 to dismiss a selected best design practice violation warning. In one implementation, upon selecting the dismissal option 272, the user is presented with a window for entering a dismissal comment, such as window shown in the simulated screen 290 of FIG. 10. The dismiss warning gives a detailed description 292 of the warning, and provides a field for entering a dismissal comment 294. Upon selecting OK option 296, the best design practice violation is dismissed for this particular instance. In one implementation, if the user wants to dismiss all warnings of this same type, a separate screen can be used to select a global dismissal, such as the one illustrated in FIG. 12. If the user selects Cancel option 298, then the best design practice violation is not dismissed for this particular instance.

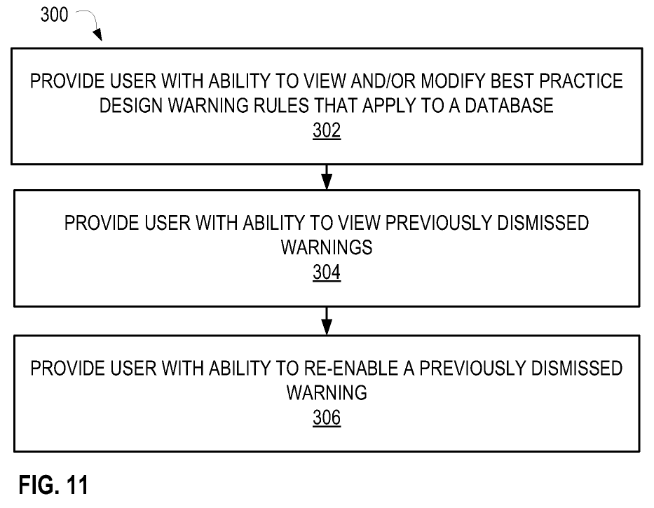

Turning now to FIG. 11, a process flow diagram 300 is shown for one implementation that illustrates the stages involved in viewing best design practice warning rules applicable to a database overall and/or viewing those warnings that have been dismissed. The user is provided with an ability to view and/or modify the best design practice warning rules that apply to a database (stage 302). The user is also provided with the ability to view a previously dismissed warning (stage 304). In one implementation, the user also is also provided with an ability to re-enable a previously dismissed warning (stage 306). The simulated screen 320 of FIG. 12 illustrates these concepts in further detail. In the design warning rules section 322 of the simulated screen 320, the various best design practice rules that are applicable to the current database are shown. The rules are categorized based upon the type of rule to which they relate, and the nodes can be expanded and/or collapsed to see a detailed description of the rule 324, the importance of the rule 326, comments 328 regarding the rule, and so on. There are numerous other ways for arranging the rules and/or for providing one or more details about the rules. The layout shown in FIG. 12 is just an example for the sake of discussion. On the same simulated screen 320, the best practice violations that have been dismissed are also displayed in the dismissed warnings section 330, including a description of the object 332, the type of object 334, a description of the object 336, the importance of the object 338, and comments 340 regarding the dismissal. Again, these are just examples of the type of data that could be displayed for a dismissed warning. Furthermore, while the dismissed warnings are shown in FIG. 12 on the same screen as the rules that apply to the current database, in other implementations, these aspects could be displayed in separate screens.

As shown in FIG. 13, an exemplary computer system to use for implementing one or more parts of the system includes a computing device, such as computing device 500. In its most basic configuration, computing device 500 typically includes at least one processing unit 502 and memory 504. Depending on the exact configuration and type of computing device, memory 504 may be volatile (such as RAM), non-volatile (such as ROM, flash memory, etc.) or some combination of the two. This most basic configuration is illustrated in FIG. 13 by dashed line 506.

Additionally, device 500 may also have additional features/functionality. For example, device 500 may also include additional storage (removable and/or non-removable) including, but not limited to, magnetic or optical disks or tape. Such additional storage is illustrated in FIG. 13 by removable storage 508 and non-removable storage 510. Computer storage media includes volatile and nonvolatile, removable and non-removable media implemented in any method or technology for storage of information such as computer readable instructions, data structures, program modules or other data. Memory 504, removable storage 508 and non-removable storage 510 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 500. Any such computer storage media may be part of device 500.

Computing device 500 includes one or more communication connections 514 that allow computing device 500 to communicate with other computers/applications 515. Device 500 may also have input device(s) 512 such as keyboard, mouse, pen, voice input device, touch input device, etc. Output device(s) 511 such as a display, speakers, printer, etc. may also be included. These devices are well known in the art and need not be discussed at length here.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the examples discussed herein could be organized differently on one or more computers to include fewer or additional options or features than as portrayed in the examples.

What is claimed is:

1. A computer-readable medium having computer-executable instructions for causing a computer to perform steps comprising:
integrating a plurality of rules for best design practices into an object model of a database;
as the database design changes, detecting one or more violations to the rules; and
outputting a notification of the one or more violations of the rules.

2. The computer-readable medium of claim 1, wherein the outputting step is operable to send the notification to a software development environment that contains a software project that uses the database.

3. The computer-readable medium of claim 1, wherein the outputting step is operable to display the notification within a visual designer of the database.

4. A method for indicating best design practice violations comprising the steps of:
receiving at least one change to a database design of a database from within a development environment;
detecting that the at least one change causes a violation to at least one best design practice; and
indicating the violation to the best design practice.

5. The method of claim 4, wherein the at least one best design practice is integrated into an object model of the database.

6. The method of claim 4, wherein the indicating is performed by displaying a warning within the development environment.

7. The method of claim 6, wherein the warning is displayed inside a list that is designed to display a plurality of warnings.

8. The method of claim 6, wherein the warning is a single warning that is displayed to notify a user of the violation to the best design practice that was just detected.

9. The method of claim 6, wherein the warning is displayed as a graphical icon.

10. The method of claim 9, wherein when a user moves an input device over a region where the graphical icon is located, a tooltip is displayed that contains more details about the violation.

11. The method of claim 9, wherein when a user selects the graphical icon, a separate window that contains more details about the violation is displayed.

12. The method of claim 4, wherein the indicating is performed by omitting a sound from within the development environment.

13. The method of claim 4, wherein when the development environment first loads, existing best design practice violations are displayed within the development environment.

14. A method for validating a database for violations of best design practices comprising the steps of:
receiving a request to validate a selected database for best design practices;
performing a best design practices check against the selected database to identify if any violations are present, the selected database having the best design practices integrated into an object model of the database; and
outputting any violations that were identified while performing the best design practices check.

15. The method of claim 14, further comprising:
receiving a request from a user to select and dismiss a violation that was identified.

16. The method of claim 15, further comprising:
receiving a comment from the user when dismissing the selected violation to indicate a reason for the dismissal.

17. The method of claim 14, wherein the request to validate the selected database is initiated by a user within a database design environment.

18. The method of claim 14, wherein the request to validate the selected database is initiated by a user within a software development environment.

19. The method of claim 14, wherein the request to validate the selected database is performed within a software development environment automatically as part of a build process.

20. The method of claim 14, wherein the request to validate the selected database is performed programmatically, and wherein the outputting of any violations is written to a file for further analysis.
